(19) United States
(12) Patent Application Publication
(10) Pub. No.: US 2025/0389921 A1
(43) Pub. Date: Dec. 25, 2025

(54) FIBER OPTIC CABLE LABELING SYSTEM AND METHODS OF MANUFACTURING THE SAME

(71) Applicant: LiteLinx Broadband Solutions, Inc., Albany, NY (US)

(72) Inventors: Yishai Amsterdamer, Albany, NY (US); Harshul Garg, Kanata (CA); Shanmugham Kalaicheivan, Toronto (CA)

(73) Assignee: LiteLinx Broadband Solutions, Inc., Albany, NY (US)

(21) Appl. No.: 19/305,355

(22) Filed: Aug. 20, 2025

Related U.S. Application Data
(63) Continuation-in-part of application No. PCT/US2025/020264, filed on Mar. 17, 2025.
Application No. PCT/US2025/020264 is a continuation-in-part of application No. 18/811,967, filed on Aug. 22, 2024, now Pat. No. 12,449,621.
(60) Provisional application No. 63/566,683, filed on Mar. 18, 2024.

(51) Int. Cl. G02B 6/44

(52) U.S. Cl. CPC G02B 6/4482

(57) ABSTRACT

A cable has a first end and a second end with a length of the cable being defined between the first end and the second end. The cable includes an outer jacket, a plurality of internal lines disposed within the outer jacket, and a plurality of label secured at predetermined intervals along the length of the cable. Each label of the plurality of labels includes an electronic tag configured to communicate with a scanner external to the cable. Each electronic tag has information relevant to the cable stored thereon. The information relevant to the cable includes at least a unique serial number associated with each respective electronic tag.

### CROSS-REFERENCE TO RELATED APPLICATIONS

This application is a continuation-in-part of International Patent Application PCT/US25/20264, filed Mar. 17, 2025, which claims benefit of, and priority to, U.S. patent application Ser. No. 18/811,967, filed Aug. 22, 2024, which claims benefit of, and priority to, U.S. Provisional Patent Application Ser. No. 63/566,683, filed Mar. 18, 2024. The entire contents of each of the above applications are hereby incorporated by reference.

### BACKGROUND

### 1. Technical Field

The present disclosure relates to cables and, more specifically, a cable that includes one or more labels having information relevant to the cable.

### 2. Discussion of Related Art

When installing infrastructure, it may be difficult to identify and track individual cables. Some current methods include using cables with different color outer jackets or covers, placing labels on or adjacent the ends of the cables, or otherwise marking the cables in the field. These methods present significant challenges to cable inventory and identifying specific cables once installed. Maintaining accurate records of cable stock is difficult due to the vast quantity and variety of cables used, often leading to overstocking or stockouts. Manual tracking methods are prone to errors, further complicating inventory management. Additionally, identifying defective cables is a daunting task without detailed installation records. The current methods may cause difficulty in identifying cables at locations other than the ends of the cables that are readily accessible by technicians. This can make replacing potentially defective cables prior to cable failure difficult.

Current technology has sought to address some of the above-described shortcomings with limited success. For example, U.S. Patent publication No. 2010/0224328 of Utaka (“Utaka”) describes RFID tags that are embedded in the insulation layer of strand wires or attached to a strand bundle covering, before sheathing of the cable, for identification of the cable during manufacturing and deployment. U.S. Patent Publication No. 2011/0025467 of Longhurst (“Longhurst”) describes embedding tags in water-swellable tape once the tape is wrapped around the cable strands for fiber cables. The tape is wrapped around the cables strands, beneath the sheathing. The tape is applied to the cable with edges of the tape overlapping in a direction parallel to the longitudinal axis of the cable and the tags are embedded in the tape before overlapping the tags. When water penetrates the cable the water-swellable tape acts to seal portions of the cable to resist further penetration to the tags. U.S. Pat. No. 7,760,094 to Kozischek (“Kozischek”) places tags at intervals in cables for network mapping. Still other technologies have integrated tracking into terminals, as opposed to cables themselves. For example, U.S. Pat. No. 8,554,033 to Kewitsch (“Kewitsch”) describe RFID tags disposed in terminals, such as Multiport Service Terminals (MST), for connection tracking to verify port assignments.

Efforts have been made to develop systems for real-time updates on inventory levels and accurate tracking of cable installation. For example, U.S. Patent Publication No. 2008/0240724 of Aguren (“Aguren”) describes monitoring cables in data centers with RFID tags disposed in the connector ends of cables. However, the systems have proven challenging to develop and implement. These challenges are only exacerbated when portions of a single cable are installed across a diffuse area. For example, discrete lengths of cable may be cut from a single spool of cable and installed in several locations. Without precise and accurate tracking of where these lengths of cable are installed, it can lead to inaccurate inventory records and, in the case of defective cables, potentially multiple points of failure.

Further still, some systems have been developed for management of cable deployment. For example, those systems offered by Sitetracker™ or IntelliFinder™ allow for tracking of the deployment locations of cables. However, these systems do not allow automatic validation of a deployed cable network against the engineering design to flag mistakes in deployment. One proposed solution is creation of a digital twin of the deployed network that can be automatically cross-checked against the engineering design to validate installation.

### SUMMARY

Accordingly, there is a need for improved cables and systems for tracking inventory and installation locations of cables. This disclosure relates generally to a labeling system for cables including fiber optic cables, and methods of manufacturing the same, capable of electronically tracking information relevant to a particular cable or portions thereof.

In an aspect of the present disclosure, a cable with a first end and a second end that define a length between the first end and the second and includes an outer jacket, a plurality of internal lines, and a plurality of labels. The plurality of internal lines are disposed within the outer jacket. The plurality of labels are secured at predetermined intervals along the length of the cable. Each label of the plurality of labels includes an electronic tag. Each electronic tag includes information relevant to the cable and is configured to be read by a scanner external to the cable.

In aspects, information relevant to the cable includes a length mark of the cable at the respective label of the plurality of labels. Information relevant to the cable may include a production batch of the cable or serial number of the cable. Each electronic tag may be disposed within the outer jacket of the cable. Each electronic tag may be embedded in the outer jacket of the cable.

In some aspects, each label of the plurality of labels may include visual indicia on the outer jacket. The visual indicia may include a link marked indicating a length of the cable at the respective label. The predetermined intervals may be 1 foot, 1 yard, or 1 meter. One or more lines of the plurality of internal lines may include one or more filaments of optical fiber.

In another aspect of the present disclosure, a cable that has a first end and a second end that define a length of the cable therebetween and includes an outer jacket, a plurality of internal lines, and a plurality of labels. The plurality of internal lines are disposed within the outer jacket. The plurality of labels are secured at predetermined intervals along the length of the cable. Each label of the plurality of labels includes an electronic tag and visual indicia that includes information relevant to the cable. Each electronic tag is configured to be read by a scanner external to the cable. Each visual indicia is printed on or is applied to the outer surface of the outer jacket.

In aspects, the visual indicia includes a length mark of the cable at the respective label of the plurality of labels. The electronic tag may include a length mark of the cable at the respective label of the plurality of labels. The electronic tag may also include a production batch of the cable or serial number of the cable.

In some aspects, each electronic tag is disposed within the outer jacket of the cable. Each electronic tag may be embedded in the outer jacket of the cable. The predetermined intervals may be 1 foot, 1 yard, or 1 meter.

In another aspect of the present disclosure, a method of manufacturing a cable includes sheathing a plurality of lines to form a cable and labeling the cable at predetermined intervals along the length of the cable. Labeling the cable includes disposing of an electronic tag within an outer jacket of the cable and associating information relevant to the cable with each electronic tag.

In some aspects, associating information relevant to the cable with each electronic tag includes associating a respective length mark of the cable with the respective electronic tag. Associating information relevant to the cable with each electronic tag may include associating a production batch of the cable or serial number of the cable with each electronic tag. Disposing the electronic tag within the outer jacket may include embedding the electronic tag in an internal or an external surface of the outer jacket.

In certain aspects, labeling the cable may include providing visual indicia the on the outer surface of the outer jacket of the cable. Providing the visual indicia on the outer surface of the outer jacket cable may include printing or stickering individual indicia on the outer surface. Providing visual indicia on the outer surface may include providing visual indicia at each electronic tag.

In another aspect of the present disclosure, a method of installing a cable includes unspooling a portion of the cable from a carrier and scanning the cable with a scanner as the cable is unspooled. The method may also include logging a scanned label of the cable while unspooling the portion of the cable and providing the log scanned labels to a tracking system after unspooling the portion of the cable.

In aspects, scanning the cable with the scanner includes the scanner being mounted to a machine or tool holding the cable on the spool. Logging the scanned label may include the scanner transmitting a signal to a computing device indicative of the scanned label. Scanning the cable with the scanner may include the scanner reading the electronic tag disposed within the outer jacket of the cable. Scanning the cable with the scanner may include identifying the electronic tag of the label at predetermined intervals along the length of the cable. Logging the scanned label of the cable may include associating the physical location of the scanned label with the scanned label.

In another aspect of the present disclosure, a cable has a first end and a second end with a length of the cable being defined between the first end and the second end. The cable includes an outer jacket, a plurality of internal lined disposed within the outer jacket, and a plurality of labels secured at predetermined intervals along the length of the cable. Each label of the plurality of labels includes an electronic tag configured to communicate with a scanner external to the cable. Each electronic tag has information relevant to the cable stored thereon. The information relevant to the cable includes at least a unique serial number associated with each respective electronic tag.

In aspects, the electronic tag is a read-write tag, a read-only tag, or a write one read many tag. The electronic tag may be configured to have information relevant to the cable written thereon before or after installation of the cable. The information relevant to the cable may include a length mark of the cable at the respective label of the plurality of labels. The information relevant to the cable may include a production batch of the cable or a serial number of the cable. The information relevant to the cable includes GPS coordinates of an installation location of the electronic tag.

In some aspects, the electronic tag is disposed within the outer jacket of the cable. The electronic tag may be embedded in the outer jacket of the cable. Each label of the plurality of labels may include a length mark indicating a length of the cable at the respective label.

In another aspect of the present disclosure, a cable has a first end and a second end with a length of cable being defined between the first end and the second end. The cable includes an outer jacket having an outer surface, a plurality of internal lines disposed within the outer jacket, and a plurality of labels secured at predetermined intervals along the length of the cable. Each label of the plurality of labels includes an electronic tag and a visual indicia. Each electronic tag has information relevant to the cable stored thereon. Each electronic tag is configured to communicate with a scanner external to the cable. The information relevant to the cable includes at least a unique serial number associated with each respective electronic tag. Each visual indicia is printed on or applied to the outer surface of the outer jacket. Each visual indicia includes information relevant to the cable.

In aspects, the information relevant to the cable includes a manufacturing date of the cable. The electronic tag may be configured to have information relevant to the cable relevant the cable written thereon before or after installation of the cable. Each electronic tag may be disposed within the outer jacket of the cable.

In another aspect of the present disclosure, a method of manufacturing a cable includes sheathing a plurality of lines to form a cable and labeling the cable at predetermined intervals along a length of the cable. Labeling the cable includes disposing an electronic tag within an outer jacket of the cable. Labeling the cable also includes registering the information relevant to the cable on a cable database. The relevant information includes at least a unique serial number associated with each respective electronic tag.

In aspects, the method includes associating information relevant to the cable with each electronic tag. Associating information relevant to the cable with each electronic tag may include associating a respective length mark of the cable with the respective electronic tag. Registering information relevant to the cable with each electronic tag may include associating a respective length mark of the cable with the respective electronic tag. Registering the length mark of each electronic tag on the cable database calculate and records a total cable length on the cable database. Associating information relevant to the cable with each electronic tag may include associating a production batch of the cable or a serial number of the cable with each electronic tag. Registering information relevant to the cable on the cable database may include associating design match data with each electronic tag.

In another aspect of the present disclosure, a method of installing a cable includes unrolling a length of a cable from a spool. The method also includes scanning, with a scanner, electronic tags of the length of the cable to read a unique serial number of each electronic tag. The method also includes logging the unique serial number of the electronic tag on cable database.

In aspects, scanning the electronic tags occurs contemporaneously with unrolling the cable from the spool. Scanning the tags of the cable may occur after the length of cable is unrolled from the spool.

In some aspects, the method includes acquiring a GPS location of each electronic tag and associating the GPS location with each respective electronic tag on the cable database. Acquiring the GPS location of the electronic tags includes acquiring a depth of each electronic tag and associating the depth with each respective electronic tag on the cable database. The method may also include associating the GPS location and the depth of electronic tag with design match data of each respective electronic tag. The method may also include correlating the design match data of each electronic tag with an engineering design to create a digital twin. Correlating the design match data with the engineering design includes indicating deviations between the engineering design and the digital twin.

In certain aspects, logging the unique serial number of the electronic tags on the cable database includes associating the unique serial number of the electronic tags on the cable database with the cable to track a length of the cable remaining on the spool.

In particular aspects, the method includes associated information relevant to the length of the cable unrolled from the spool with the unique serial number of each electronic tag thereof on the cable database. Associating information relevant to the length of the cable unrolled from the spool may include associating a cable serial number, a SKU number, or a production batch with each electronic tag on the cable database.

In aspects, the method includes selecting the spool before unrolling the length cable from the spool. The spool may be selected based on a length cable contained on the spool associated with a spool identifier on the cable database. Associating information relevant to the length of the cable unrolled from the spool may include associating the length of cable remaining on the spool with the spool identifier on the cable database. Associating the length of cable remaining on the spool may include associating the spool identifier with an installation vehicle identifier on the cable database. Logging the unique serial number of the electronic tags may include continuously commuting the unique serial number to the cable database.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a side view of a portion of a cable provided in accordance with the present disclosure with internal lines of the cable exposed;

FIG. 2A is a cross-sectional view of the cable of FIG. 1;

FIG. 2B is a cross-sectional view of another cable in accordance with embodiments of the present disclosure;

FIG. 2C is a perspective view of a spool of tag tape in accordance with embodiments of the present disclosure;

FIG. 3 is a side view of a portion of another cable provided in accordance with the present disclosure with internal lines of the cable exposed;

FIG. 4 is a cross-sectional view of the cable of FIG. 3;

FIG. 5 is a schematic view of equipment for manufacturing a cable in accordance with the present disclosure;

FIG. 6 is a schematic view of equipment for manufacturing a cable in accordance with

the present disclosure;

FIG. 7 is a schematic view of equipment for manufacturing a cable in accordance with the present disclosure;

FIG. 8 is a flowchart of a method for installing cable in accordance with the present disclosure;

FIG. 9 is a flowchart illustrating a project management workflow in accordance with embodiments of the present disclosure;

FIG. 10 is a perspective view of an example remote drone in accordance with embodiments of the present disclosure; and

FIG. 11 is a perspective view of another remote drone in accordance with embodiments of the present disclosure.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

This disclosure relates generally to labeling systems for cables. The label system may allow for labeling different types of cables including optical cables such as fiber optical cables, electrical cables, networking cables, coaxial cables, and other types of cables. The labeling system may include labels adjacent the ends of the cables 10. In some embodiments, the labeling system may include labels at predetermined intervals along the length of the cable 10. For example, the labels may be disposed at intervals along the length of the cable with each interval being 1 foot, 1 yard, 1 meter, or other conventional unit of measurement suitable for the length of the cable.

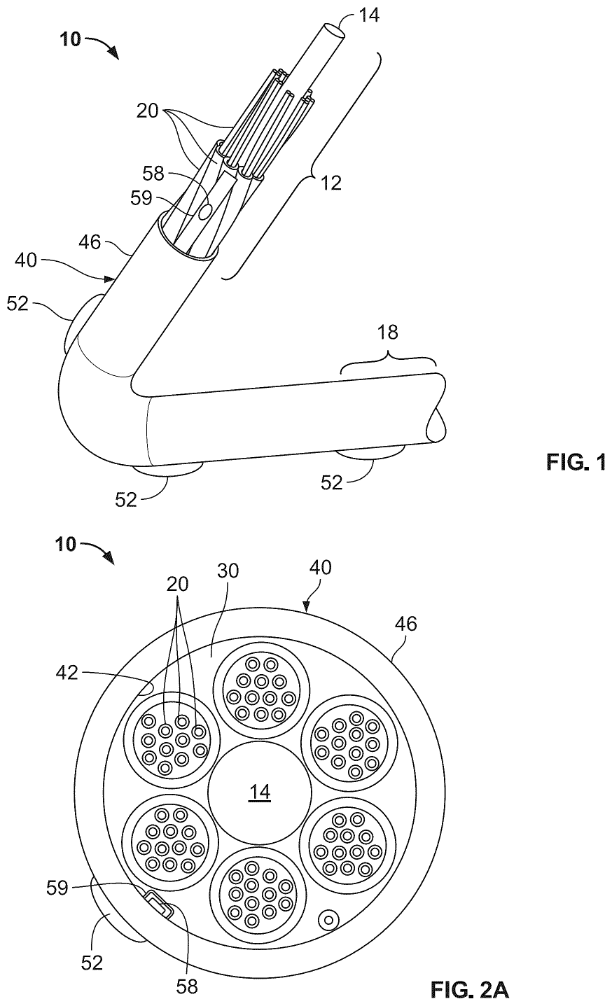

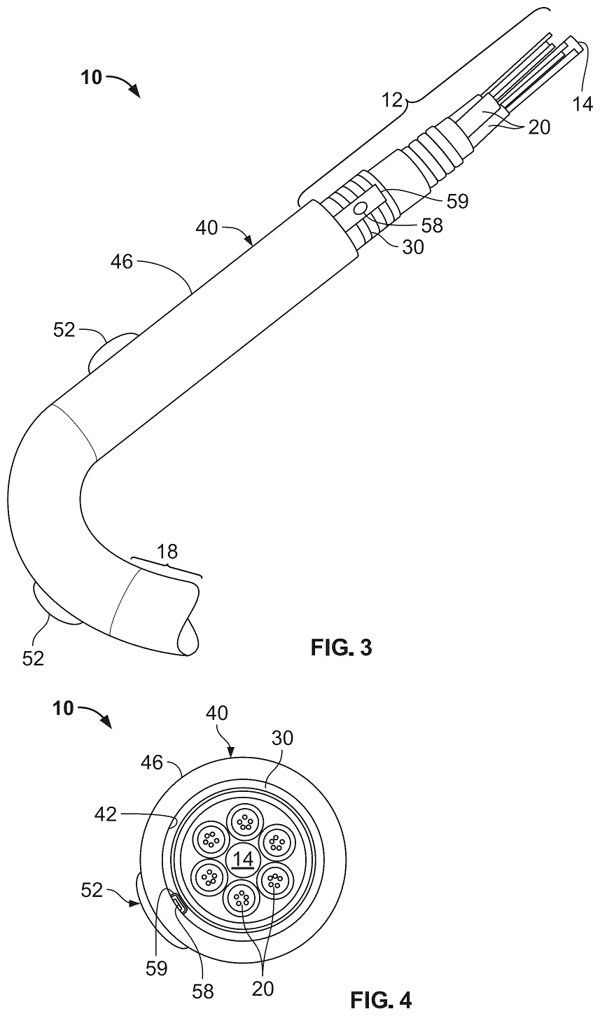

Referring now to FIGS. 1-4, cables are provided according to the present disclosure and are referred to generally as cable 10. The cable 10 includes a first end portion 12 and a second end portion 18. The first end portion 12 and/or the second end portion 18 may include one or more connectors or terminators (not explicitly shown) that connect the cable 10 to equipment or other cables such that one or more signals are transmitted through the cable 10.

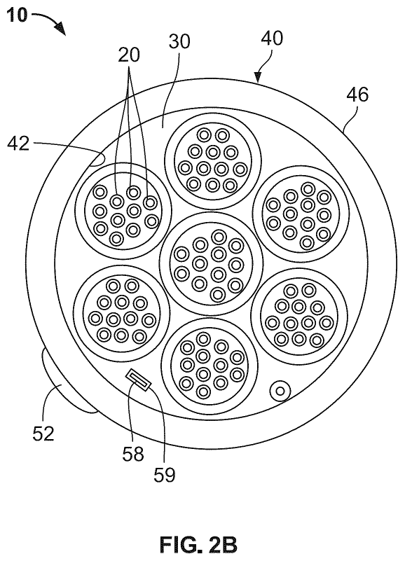

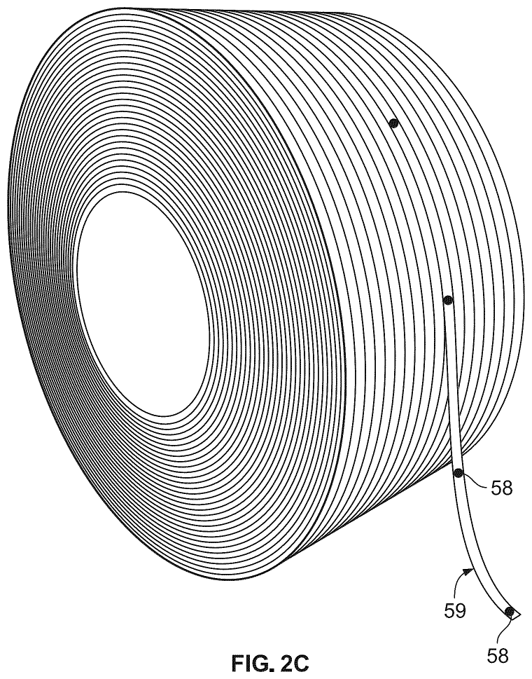

The cable 10 may include one or more internal lines 20. Each internal line 20 is formed of a suitable transmitter to transmit a signal along the length of the cable 10. Each internal line 20 may be a single filament optical fiber, a multifilament optical fiber, a solid core metallic wire, a multifilament metallic wire, or the like. When the cable 10 includes one or more filaments of optical fiber, the cable 10 may be considered a fiber optic cable. Each internal line 20 may include an insulative layer, a shield layer, and/or a cover layer. The insulative layer, the shield layer, and/or the cover layer may physically, optically, or electrically protect or shield the respective internal line 20 from the other internal lines 20 or an environment exterior to the cable 10. In embodiments, a core 14 of the cable 10 may be made of a toneable material, e.g., a metallic material such as copper, or a non-toneable material, e.g., a polymeric material such as thermoplastic polyurethane (TPU) or polyvinyl chloride (PVC). The core 14 may extend the entire length of the cable 10. With particular reference to FIG. 2B, in some embodiments the cable 10 may be provided without a core 14. In certain embodiments, the cable 10 is substantially non-metallic. In such embodiments, the electronic tags 58 may allow for location of the cable after installation as described in greater detail below.

The cable 10 includes an outer jacket 40 and may include an inner liner 30. The outer jacket 40 is disposed about the internal lines 20 such that the internal lines 20 are all within the outer jacket 40. The inner liner 30 may be disposed about all of the internal lines 20 to secure the internal lines 20 in position with one another. For example, the inner liner 30 may secure the internal lines 20 in a braided configuration with one another, a parallel configuration with one another, a coaxial configuration with one another, or a combination thereof. The inner liner 30 is disposed within the outer jacket 40.

The outer jacket 40 includes an interior surface 42 and an external surface 46. The cable 10 includes a label 52 that is disposed on the interior surface 42 or the external surface 46 of the outer jacket 40. In some embodiments, the label 52 is disposed within the interior surface 42. For example, the label 52 may be disposed between the interior surface 42 and an inner liner 30. In certain embodiments, the label 52 may be disposed between the interior surface 42 and the internal lines 20.

The label 52 includes pieces of information related to the cable 10. The pieces of information related to the cable 10 may include, but is not limited to, a serial number of the cable 10, a stock keeping unit (SKU) of the cable 10, a name of the product, a production batch of the cable 10, or combinations thereof. In some embodiments, the information related to the cable 10 may include a length mark for the specific cable. For example, a label 52 at a first end portion 12 of a respective cable 10 may include a first length mark and another label 52 at a X number of length units along the cable 10 may include a second length mark to provide indicia of the X number of length units. Specifically, a first length mark may be “1” and a second length mark 1 meter down the length of the cable 10 may be “2”.

The label 52 may be applied to the external surface 46 of the outer jacket 40 by adhesive glue or by printing directly on the outer jacket 40. The label 52 may be applied within the outer jacket 40 with tape such as water blocking tape, armor, tubes, or yarns. In some embodiments, the label 52 is a sticker that is applied to the external surface 46. In certain embodiments, the label 52 may be printed directly to the external surface 46. In particular embodiments, the label 52 may be burned directly into the external surface 46. When the label 52 is disposed on or in the external surface 46, the label 52 may provide one or more pieces of the information as visual information that can be read directly by a user. In some embodiments, the label 52 may provide one or more pieces of information by a code, e.g., a bar code or a quick response code “QR” code. For example, a length mark may be provided as visual information and the rest of the information may be in the form of a QR code.

The label 52 may include electronic tags or markers. For example, the label 52 may include an electronic chip or tag 58. The electronic tag 58 may be a radio frequency identification tag “RFID tag,” such as an ultra-high frequency tag “UHF tag” or a very high frequency tag “VHF tag,” or a near-field communication tag “NFC tag” that includes one or more pieces of information. In some embodiments, the electronic tag 58 may be applied to or embedded in the external surface 46 of the outer jacket 40. In certain embodiments, the electronic tag 58 may be embedded in the interior surface 42 of the outer jacket 40. In particular embodiments, the electronic tag 58 may be disposed on or secured to the inner liner 30 with the outer jacket 40 disposed over the electronic tag 58 and the inner liner 30. The label 52 may be marked on the external surface 46 adjacent to or over an electronic tag 58 disposed within the outer jacket 40.

The electronic tags 58 may be adapted for managing inventory and logistics of manufacturing, installing, or monitoring the cable 10. Each electronic tag 58 may have a unique identifier or serial number associated with the respective electronic tag 58. The serial number of the electronic tag 58 may be hexadecimal, hexadecimal reversed, or other serial number encoding paradigm. The electronic tag 58 may have electronic storage sized to only store the unique serial number of the electronic tag 58. In such an embodiment, the electronic tag 58 may have a size to allow flexibility of the cable 10. For example, the flexibility of the cable 10 may not be affected by the inclusion of the electronic tag 58.

The electronic tags 58 may be configured to communicate with a scanner. The scanner may be in signal communication with a cable database. The scanner may be in continuous or intermittent signal communication with the cable database. The scanner may be configured to read and upload the unique serial number of the electronic tag 58 to the cable database. Once the cable database is populated with the unique serial numbers of the electronic tags 58, information relevant to the cable 10 may be associated with each of the unique serial numbers and, thus, each respective electronic tag 58 within the cable database. For example, in the cable database, each unique serial number may be listed as being associated with pieces of information including, but not limited to, a cable serial number, a batch number, a production date, a length position on the cable, a total length of the cable, a spool identifier, or an installation vehicle identifier. The electronic tag 58 may be a read-only tag. Where the electronic tag 58 is a read-only tag, the information stored on the electronic tag 58, e.g., the unique serial number of the electronic tag 58, may be read by the scanner but the scanner may not write information to the electronic tag 58.

With particular reference to FIGS. 2A-2C a tag tape 59 in accordance with embodiments is shown. The tag tape 59 may act as a substrate for the electronic tags 58. The tag tape 59 may attach to the interior surface 42 of the outer jacket 40 to secure the electronic tags 58 at respective locations along the length of the cable 10 (FIG. 2A). In certain embodiments, the tag tape 59 may be embedded within the outer jacket 40 (FIG. 2B). The tag tape 59 may be a continuous tape extending along the entire length of the cable 10. The tag tape 59 may extend parallel to the longitudinal length of the internal lines 20. In some embodiments, the tag tape 59 may be helically wrapped about the internal lines 20. The electronic tags 58 may be attached to the electronic tags 58 such that the electronic tags 58 are disposed along the length of the cable 10 at regular intervals. For example, the electronic tags 58 may be disposed along the tag tape 59 in a range of 0.5 meters to 10 meters, e.g., 0.5 meters, 1 meter, 1.5 meters, 2 meters, 3 meters, 5 meters, 8 meters, or 10 meters, such that the electronic tags 58 are located at regular intervals along the length of the cable 10. For example, in embodiments that the tag tape 59 extends the length of the cable 10 parallel to the longitudinal length of the internal lines 20 the electronic tags 58 may be disposed at 1 meter intervals along the length of the tag tape 59 such that electronic tags 58 are disposed at 1 meter intervals along the length of the cable 10. In embodiments that the tag tape 59 is helically wrapped about the internal lines 20, the electronic tags 58 may be disposed at a different interval along the length of the tag tape 59 than the interval the electronic tags are disposed along the length of the cable 10 to accommodate the pitch of the wrapping of the tag tape 59. For example, the electronic tags 58 may be disposed at 1.5 meter intervals along the length of the tag tape 59 such that when the tag tape 59 is wrapped about the internal lines 20 the electronic tags 58 are disposed at 1 meter intervals along the length of the cable 10.

In embodiments, the tag tape 59 may be secured to the cable 10 by an adhesive. The tag tape 59 may be adhered to the interior surface 42 of the outer jacket 40. In some embodiments, the tag tape 59 may adhered to an armor layer, e.g., a metallic inner liner 30 (FIG. 4), of the cable 10. In some embodiments, the tag tape 59 may be embedded in a water swellable tape or layer. The water swellable layer may be wrapped around the internal lines 20. The water swellable layer may protect the internal lines 20 from moisture. For example, the water swellable layer may swell to engage the interior surface 42 and seal the cable 10 to resist ingress of the water into the cable 10, without impeding readability of the electronic tags 58. In embodiments, the tag tape 59 includes two or more layers that sandwich the electronic tags 58 therebetween. For example, the tag tape 59, including the electronic tags 58, may be sandwiched between two layers of polyethylene terephthalate (PET). Sandwiching the electronic tags 58 between two layers of the tag tape 59 may shield the electronic tags 58 from mechanical, e.g., abrasion, and environmental conditions, e.g., chemicals, that may damage the electronic tags 58. In certain embodiment, a separation layer is disposed between the tag tape 59 and any metallic surface, e.g., an armor layer of the cable 10. The separation layer is a non-conductive material that insulates the tag tape 59 from signal degradation.

The electronic tags 58 may be attached the tag tape 59 by an adhesive. In embodiments where the tag tape 59 includes two or more layers the layers may be bonded together with the electronic tags 58 disposed therebetween.

In embodiments, the tag tape 59 may be configured to stabilize the core 14 of the cable 10. For example, in embodiments that the tag tape 59 is helically wrapped about the internal lines 20, the tag tape 59 may resist separation of the internal lines 20. The tag tape 59 may be wrapped about the internal lines 20 in an overlapping manner to entirely wrap the internal lines 40. The overlapping edges of the tag tape 59 may run parallel to the axis of the cable 10. In some embodiments, the tag tape 59 may reduce misalignment of the electronic tags 58 along the length of the cable 10. Additionally or alternatively, the tag tape 59 may protect the labels from environmental conditions that may otherwise damage the electronic tags 58. For example, the tag tape 59 may isolate the labels from mechanical stresses during manufacturing or deployment, e.g., abrasion forces. In some embodiments, the tag tape 59 may protect the electronic tags 58 from moisture.

The tag tape 59 is configured for tracking of the cable 10 when the cable 10 is buried underground. In embodiments, a cable 10 with the tag tape 59 may be detectable up to 5 feet (1.6 meters) underground. In some embodiments, a cable 10 with the tag tape 59 may be detectable up to 3 feet, 4 feet, 6 feet, 7 feet, 8 feet, 9 feet, 10 feet, 0.5 meters, 1 meter, 1.5 meters, or 2 meters underground. Specifically, the tag tape 59 may be configured for propagation of signals emitted by the electronic tags 58, e.g., radio waves, through soil. In such embodiments, the electronic tags 58 on the tag tape 59 may emit signals of uniform strength across the entire length of the cable 10. In some embodiments, the electronic tags 58 may include signal boosters ensure the electronic tags 58 to penetrate soils of various conditions, e.g., sandy soil, clay soil, or wet soil. For example, in wet, rocky soil the electronic tags 58 may transmit a signal with a strength in a range of −60 decibel milliwatts (dbm) to −100 decibel milliwatts, e.g., −60 dbm-65 dbm, −70 dbm, −85 dbm, −95 dbm, or −100 dbm, when the cable is buried at a depth up to 5 feet. The signal boosters may be low-frequency antennas. The tag tape 59 may be made of a flexible material that does not inhibit the flexibility of the cable 10. For example, the tag tape 59 may be made of a polymeric material. The polymeric material may be a polyester or a polyimide. In certain embodiments, the polymeric material may be modified with functional chemistries to alter properties of the tag tape 59 such as thermal resistance, chemical resistance, or resistance to electrostatic discharge. The flexible material of the tag tape 59 may a have dielectric properties compatible with RFID frequencies to promote propagation of communication signals between the electronic tags 58 and a scanner. In some embodiments, the tag tape 59 may resist degradation when exposed to ultraviolet light (UV light) or chemicals. In particular embodiments, the material of the tag tape 59 may be waterproof or dust proof. For example, the tag tape 59 may meet IP68 ratings.

In certain embodiments, the tag tape 59 is made of a material that withstands temperatures in a range of 200 degrees Celsius to 250 degrees Celsius, e.g., 200 degrees Celsius, 210 degrees Celsius, 215 degrees Celsius, 225 degrees Celsius, 230 degrees Celsius, 245 degrees Celsius, or 250 degrees Celsius, without melting or deforming. The resistance of the tag tape 59 to melting or other temperature related deformation may reduce or prevent failure of the electronic tags 58 disposed on the tag tape 59 when exposed to high-heat processes such as extrusion processes during manufacturing of the cable 10. In such embodiment, the material's resistance to melting or deformation at high temperatures may reduce heat related failure of the electronic tags 58 during manufacturing to less than 1-percent.

In some embodiments, the tag tape 59 is made of a material having a low dielectric constant. For example, the tag tape 59 may have a dielectric constant in a rang of 3 to 4, e.g., a dielectric constant of 3, 3.1, 3.4, 3.6, 3.9, or 4. The low dielectric constant of the tag tape 59 may minimize attenuation of the signal emitted from the electronic tags 58. In embodiments, the material of the tag tape 59 supports transmission of ultra-high frequency (UHF) signals, e.g., signals with a frequency in a range of 300 MHz to 3 GHz, with minimal signal attenuation. For example, the low dielectric material of the tag tape 59 may allow the electronic tags 58 to be scanned with 95-percent readability when buried in a varied soil, e.g., clay and sand spoil at a 20-percent to 40-percent hydration, at a depth of 5 feet.

In certain embodiments, the material of the tag tape 59 may have a tensile strength greater than 50 MPa, e.g., 50 MPa, 60 MPa, 75 MPa, or 100 MPa. The tag tape 59 may exhibit an elongation greater than 100-percent before breaking. The tag tape 59 may have a thickness in a range of 0.05 millimeters to 0.1 millimeters, e.g., 0.05 millimeters, 0.07 millimeters, or 0.09 millimeters. The material of the tag tape 59 may have ant-static properties to resist or prevent electrostatic discharge that may damage the electronic tags 58.

The cable database may be a master cable database and include all of the information relevant to the cable 10. The information relevant to the cable 10 and associated with each electronic tag 58 on the cable database may include, but is not limited to, warehousing information such as warehouse location, inventory information, a serial number of the cable 10, a stock keeping unit (SKU) of the cable 10, a name of the product, a production batch of the cable 10, a manufacturing date of the cable 10, installation location, installation date, installing company or technician, maintenance logs, design match data, depth of cable, XYZ coordinates (depth and GPS coordinates) of cable or installed location, or combinations thereof. In embodiments the cable database may be in whole or in part to determine an installation cost, generate an invoice for installation, or create a digital twin of an installation. In some embodiments, the coordinates of the cable or electronic tag may be used to create a digital twin of an installation of the cable or electronic tag. In certain embodiments, the cable database may include design match data which is the difference in the installed location of the cable versus the installed location of the cable 10. In some embodiments, the cable database may be a subject matter specific database, e.g., a cable inventory database, a cable GPS database, a cable maintenance log database, a cable warehousing database, or other database. In some embodiments, the scanner may be in signal communication with more than one cable database.

In particular embodiments, the cable database may identify abnormalities in records when the scanner scans the cable 10. For example, when the cable 10 is scanned and stored in a warehouse without being registered, the cable database may identify an abnormality to be reconciled by warehouse staff. In embodiments, some abnormalities may be reconciled automatically by the cable database. For example, when the cable 10 is removed from a warehouse without being scanned, but is scanned when returned to the warehouse, the cable database may identify an abnormality and update the cable database to reflect a change in the length of the cable 10 remaining on the spool based on the records of the cable database and the data collects when the cable 10 is scanned upon return. In certain embodiments, when a cable 10 is scanned at a warehouse, one or more tags of the cable 10 may be missing but not registered during installation. The installed location of the tags may be reconciled automatically or manually. In particular embodiments, the installed location of the tags may be attempted to be automatically reconciled and escalated when reconciliation rules are not met. For example, when tags on either side of the non-registered tags are installed in a single continuous location, the installed location of the non-registered tag or tags may be averaged based on the location of the registered tags on either side of the non-registered tag. However, when the non-registered tag is at an end an installation, manual review, or registration may be required and the database may flag the non-registered tag for manual review. The automatic or manual registration may occur or be flagged when a spool is returned to a warehouse or logged on an installation vehicle.

In embodiments, different scanners may read the unique serial numbers of the electronic tags 58 at different times or locations. For example, when the cable 10 is manufactured a first scanner may read the unique serial number of each electronic tag 58 and log the unique serial numbers on the cable database. When the cable 10 is installed a second scanner may read the unique serial number of each of the electronic tags 58 and log the unique serial numbers on the cable database. Reading and logging the unique serial numbers at different times and locations may allow for tracking the cable 10 from manufacturing to installation.

Additionally or alternatively, the scanner may be configured to write information relevant to the cable 10 to the electronic tag 58 in addition to the unique serial number of the electronic tag 58. The additional information on the electronic tag 58 may include, but is not limited to, warehousing information such as warehouse location, inventory information, a serial number of the cable 10, a stock keeping unit (SKU) of the cable 10, a name of the product, a production batch of the cable 10, a manufacturing date of the cable 10, installation location, installation date, installing company or technician, maintenance logs, cost of installation, design match data, depth of cable, XYZ coordinates (depth and GPS coordinates) of cable or installed location, or combinations thereof.

Information written to the electronic tag 58 by the scanner may be contemporaneously associated with the unique serial number registered on the cable database. For example, the scanner may contemporaneously write a batch number on the electronic tag 58 and associate the unique serial number of the electronic tag 58 with the batch number on the cable database. In such an embodiment, the electronic tag 58 may be a read-write tag or a write once read many tag (“WORM tag”). Where the electronic tag 58 is a read-write tag, the information stored on the electronic tag 58 may be read by the scanner or the information may be stored, e.g., written or edited, on the electronic tag 58 by the scanner. In embodiments where the electronic tag 58 is a WORM tag, information may be written to the electronic tag 58 by the scanner once and may be read by the scanner more than once.

In particular embodiments, the scanner may display relevant information read from the electronic tag 58 to a technician. The scanner may have an interface for a technician to input relevant information for the scanner to write to the electronic tag 58. The scanner may read or write relevant information on the electronic tag 58 remotely. For example, the cable 10 may be installed as an underground cable. In such embodiments, the scanner may read or write relevant information on the electronic tag 58 without the need to dig up the underground cable.

In certain embodiments, different scanners may write information relevant to the cable 10 at different times or locations to the electronic tags 58. For example, when the cable 10 is manufactured, the first scanner may write pieces of information relevant to the cable 10 on each of the electronic tags 58 such as a manufacture date, a serial number of the cable 10, or a batch number of the cable 10. When cable 10 is installed, a second scanner may write pieces of information relevant to installation of the cable 10 such as the installation date, the installing technician, or the location of installation. In embodiments, the second scanner may delete or edit some or all of the information written by the first scanner on the electronic tag 58.

In embodiments, the labels 52 of a cable 10 may vary along the length of the cable 10. The labels 52 of a cable 10 may vary based on the location along the cable 10 or vary at set intervals along the length of the cable 10. In some embodiments, a cable 10 may include a label 52 every interval or unit along the length of the cable 10 with the unit being a meter, a foot, or a yard. In such embodiments, every label 52 may include a visual label on or in the external surface 46 of the outer jacket 40 and every other, third, fourth, or other number of labels 52 may include an electronic tag 58 including additional pieces of information. The visual label may include a length mark and/or other pieces of information with respect to the cable 10.

The labels 52 detailed above are described with respect to being on a cable 10. However, it is contemplated that the labels 52 may be used with multi service terminal (“MST”), fiber optic splice closure (“FOSC”), an aerial terminal, a wiring cabinet, a wiring closet, a rack, a shelf of a rack, or other equipment related to cabling infrastructure. In some embodiments, the labels 52 may be stickers that may be applied to an external surface of equipment during manufacture or in the field. The stickers may be self-adhesive and may include visual information and/or an embedded electronic tag 58. In such embodiments, the electronic tags 58 of the terminals may have information about the associated terminal stored thereon. For example, the electronic tags 58 may have identification information, e.g., location of a particular terminal, or compatibility information, e.g., types of cable that are compatible with a particular terminal. Storing identification information or compatibility information on the electronic tags 58 of the terminals may prevent or reduce miss-matching incompatible cables 10 and terminals.

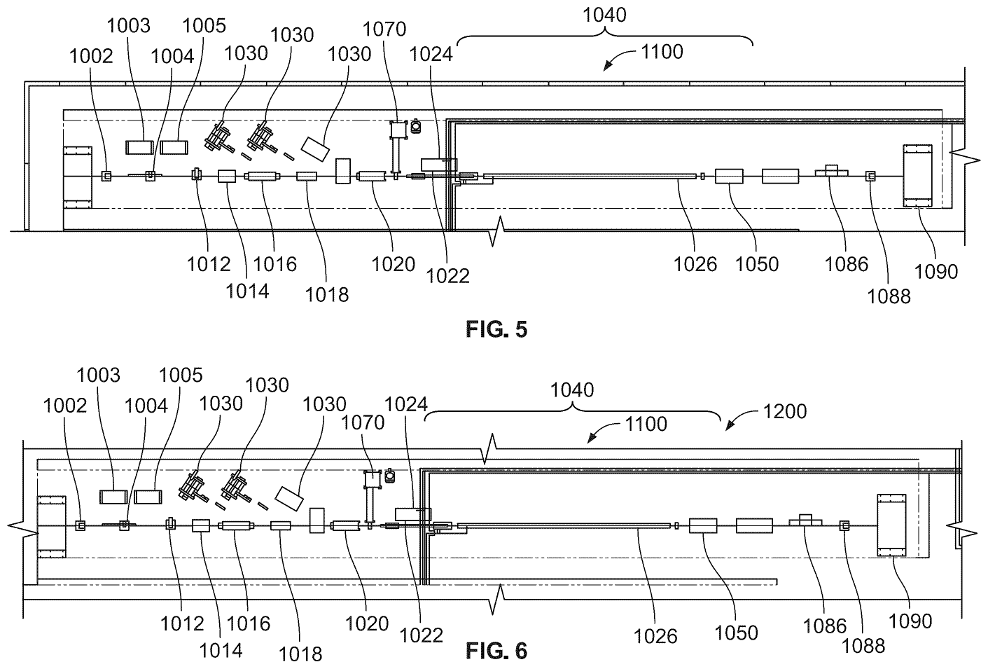

Referring now to FIG. 5, a method of manufacturing a cable is provided in accordance to the present disclosure and is referred to generally as method 1100. The cable manufactured by the method 1100 may be any of the cables 10 detailed above. The method 1100 may include forming the internal lines 20 of the cable 10 in a traditional manner with the labeling occurring in the sheathing process of manufacturing the cable 10. An example system for performing one or more steps of the method 1100 are shown in the manufacturing system 1000 shown in FIG. 5.

For example, as shown in FIG. 5, the line manufacturing the cable may include a fixed guide wheel support 1002 and a tension dancer 1004. The guide wheel support 1002 and the tension dancer 1004 may receive one or more lines from pay off tubes 1003, 1005. The system 1000 may include an aluminum or steel payoff machine 1012 that receives the lines from the tension dancer 1004 and feeds the lines with a tape to a tape welder 1014. The tape welder 1014 may provide the assembly to tape accumulator 1016 which provides the assembly to a tape corrugator 1018. The system may include a tap longitudinal forming device 1020. The system 1000 may also include one or more water troughs 1022, 1026 that receive the cable such that the cable passes therethrough. In addition, the system 1000 may include a dancer 1086, a guide wheel 1088, and a final take up device 1090. In addition, as detailed below, the system 1000 may include additional devices to label the cable 10 during manufacturing.

For example, a printer 1050 may be added in the system 1000 that will print the label 52 including visual information directly onto the external surface 46 of the cable 10 during the sheathing process of the cable 10 (Process 1150). The printer 1050 may be a high-speed printer such that the printing of the visual information may not affect the speed of the sheathing process. The printer 1050 may be loaded with software that varies the visual information of the label 52 during the sheathing process. For example, the software may increment the length mark of the label 52 with each label 52. In some embodiments, the printer 1050 may vary other pieces of information of the label 52 from each label 52 to the next. Printing the label 52 on the external surface 46 of the cable 10 may include printing a QR code onto the external surface 46 of the cable 10. When a QR code is printed onto the external surface 46, a length mark or other pieces of visual information may be included adjacent to the QR code.

With reference now to FIG. 6, another method of manufacturing a cable is provided in accordance to the present disclosure and is referred to generally as method 1200. The cable manufactured by the method 1200 may be any of the cables 10 detailed above. The method 1200 may include forming the internal lines 20 of the cable 10 in a traditional manner with the labeling occurring in the sheathing process of manufacturing the cable. Specifically, a labeling machine 1060 will be added in the sheathing equipment 1040 that will apply a label 52 including visual information onto the external surface 46 of the cable 10 during the sheathing process (Process 1250). The labeling machine 1060 may be a high-speed labeling machine such that labeling may not affect the speed of the sheathing process. The labeling machine 1060 may be loaded with software that varies the visual information of the label 52 during the sheathing process. For example, the software may increment the length mark of the label 52 with each label 52. In some embodiments, the labeling machine 1060 may vary other pieces of information of the label 52 from each label 52 to the next. Applying the label 52 on the external surface 46 of the cable 10 may include a QR code. When a QR code is included, a length mark or other pieces of visual information may be included adjacent to the QR code. In some embodiments, the method 1200 may include printing a portion of the label 52 and labeling another portion of the label 52. For example, a sticker or label may be applied including a QR code having pieces of information and other pieces of information of the label 52 may be printed directly onto the external surface 46. In some embodiments, a QR code is including pieces of information for the cable 10 is applied to the external surface 46 and a length mark is printed onto the external surface 46 adjacent to the QR code. In some embodiments, the labeling machine 1060 may apply a label 52 including an electronic tag 58. The electronic tag 58 may be applied with or without any visual information.

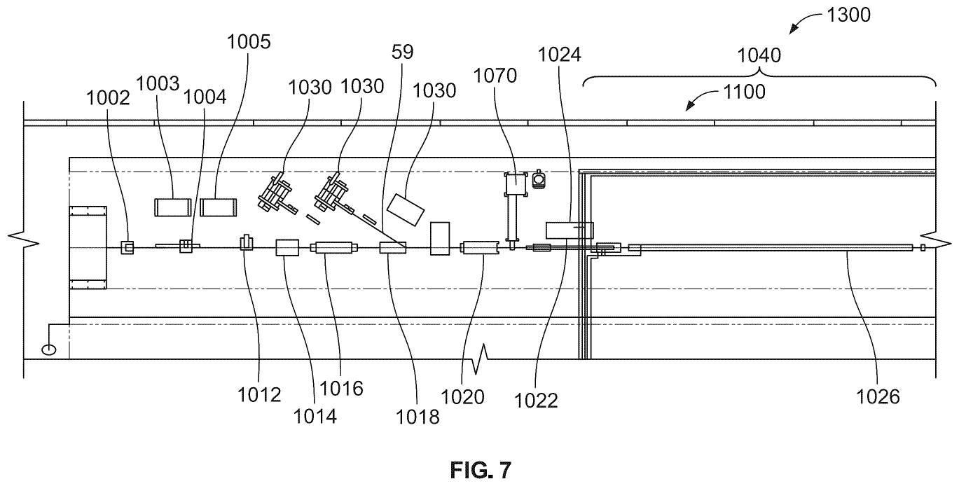

With reference now to FIG. 7, another method of manufacturing a cable is provided in accordance to the present disclosure and is referred to generally as method 1300. The cable manufactured by the method 1300 may be any of the cables 10 detailed above. The method 1300 may include forming the internal lines 20 of the cable 10 in a traditional manner with the labeling occurring before the sheathing process of manufacturing the cable. Specifically, a labeling machine 1030 will be added to the manufacturing line before the sheathing equipment 1040 that will apply a label 52 to the cable 10 (Process 1350). The labeling machine 1030 applies an electronic tag 58 to the cable 10 such that the electronic tag 58 is disposed within an outer jacket 40 after the outer jacket 40 is applied during the sheathing process. The labeling machine 1030 may be a high-speed labeling machine such that labeling may not affect the speed of the sheathing process. The labeling machine 1030 may be loaded with software that varies the electronic tags 58 before the electronic tags 58 are applied to the cable 10. The labeling machine 1030 may apply the electronic tag 58 to an inner liner 30 or sheath of the cable 10 or may position the electronic tag 58 to be secured to the interior surface 42 of the outer jacket 40 when the outer jacket 40 is applied to the cable 10. For example, the software may increment a length mark or information of the label 52 with each label 52. In some embodiments, the labeling machine 1030 may vary other pieces of information of the label 52 from each label 52 to the next. In some embodiments, the method 1300 may also include applying a portion of one or more labels 52 on the external surface 46 of the cable 10. For example, a length mark or a QR code may be applied to the external surface 46 adjacent one or more of the electronic tags 58 disposed within the outer jacket 40. When a QR code is included, a length mark or other pieces of visual information may be included adjacent to the QR code. In some embodiments, the method 1300 may include printing a portion of the label 52 and labeling another portion of the label 52. For example, a sticker or label may be applied including a QR code having pieces of information and other pieces of information of the label 52 may be printed directly onto the external surface 46. In some embodiments, a QR code is including pieces of information for the cable 10 is applied to the external surface 46 and a length mark is printed onto the external surface 46 adjacent to the QR code.

In some embodiments, the labeling machine 1030 may apply the electronic tags 58 to the cable 10 by disposing the tag tape 59 within the outer jacket 40. Applying the electronic tags 58 via the tag tape 59 may maintain the flexibility of the cable 10, as compared to applying tags directly to the outer jacket 40. In embodiments, the disposing of the tag tape 59 within the outer jacket 40 may prevent or reduce failure of the electronic tags 58, as compared to individually applying the electronic tags 58 to the outer jacket 40. For example, applying the tags 58 to the cable 10 by the tag tape 59 may avoid exposing the electronic tags 58 to extrusion pressure associated with application of the outer jacket 40. The tag tape 59 may be applied to the cable 10 concurrently with application of the outer jacket 40. For example, the tag tape 59 may be applied to the cable 10 and outer jacket 40 may be applied to the cable 10 immediately thereafter. In embodiments, the tag tape 59 may have melting temperature above the extrusion temperature. In such embodiments, the electronic tags 58 on the tag tape 59 may resist heat related failure, e.g., detaching from the tag tape 59, during extrusion processes. Additionally or alternatively, inclusion of the tag tape 59 in the cable 10 may reduce manufacturing costs. For example, the inclusion of the tags 58 may allow for use of a non-toneable core 14. For example, the core 14 may be made of a polymeric material, which may substantially reduce the material costs of the producing cable 10 compared to using a toneable core, e.g., a copper core. In particular embodiments, the cable 10 may not include a continuous toneable element. For example, the cable 10 may omit the core 14, as shown in FIG. 2B, and the cable 10 may only be tracked by scanning the electronic tags 58. In some embodiments, costs may be reduced due to the reduction or prevention of manufacturing related failures in the electronic tags 58. In such embodiments, fewer, or none, of the electronic tags 58 may require replacement thereby reducing materials and labor costs to re-work the cable 10. Further, the tag tape 59 may be disposed within the outer jacket 40 continuously. Continuous disposal of the tag tape 59 may improve the scalability of producing the cable 10. The tag tape 59 may allow for reduced complexity of equipment to unspool the tag tape 59 instead of embedding individual electronic tags 58 at locations along the length of the cable 10. In embodiments, the rate at which the cable 10 may be produced is substantially the same as conventional fiber optic cable.

The labeling machine 1030 may include a scanner that reads the unique serial number of each of the electronic tags 58 before the electronic tags 58 are applied to the cable 10. In some embodiments, the scanner may read the unique serial number of each the electronic tag 58 after the outer jacket 40 is applied. For example, the final take up device 1090 may include the scanner and read the unique serial number of the electronic tags 58 as the cable 10 is taken off the system 1000 and spooled up. In some embodiments, the scanner may register the unique serial number of the electronic tags 58 in a cable database. Registering the unique serial number of the electronic tags 58 in the database may allow for associating the electronic tags 58 with information relevant to a particular cable 10 within the cable database. For example, on the cable database, each unique serial number may be associated with a serial number of the cable 10, a SKU of the cable 10, a spool number, or other information relevant to the cable 10.

In some embodiments, one or more electronic tags 58 may be scanned to track a particular cable 10 through manufacturing and delivery to an installation site. More particularly, any of the electronic tags 58 may be scanned, once the unique serial numbers are uploaded to the cable database and associated with a particular cable 10, to identify the particular cable 10 and return the information relevant to that cable 10. For example, when the cable 10 is loaded on a truck for shipping, one or more electronic tags 58 may be scanned and a truck number may be associated with the cable 10 on the cable database. Additionally or alternatively, when the cable 10 is unloaded from a truck for delivery, one or more electronic tags 58 may be scanned and delivery information, e.g., delivery address, date, time, or recipient, may be associated with the cable 10 on the cable database.

In certain embodiments, design match data may be associated with a particular cable 10 on the cable database. More particularly, design match data may be associated with each electronic tag 58. The design match data may allow for a correlating the engineering design, e.g., fiber optic network design, to an installed location of the cable 10 to create a digital twin for the installed position of the cable 10. The design match data may include data indicative of, but is not limited to, the planned location of the cable 10, the planned depth, the grade (e.g., increase or decrease in depth), cable size, or splice locations. The design match data may be associated with the cable 10 during manufacturing when the cable 10 is spooled or at a later time when the cable 10 is selected for installation. For example, when the cable 10 is manufactured for a specific project, the design match data may be associated with the cable 10 during manufacturing. When the cable 10 is made as stock production, not for a particular project, the design match data may be associated with the cable 10 when the cable 10 is designated for installation or is installed. In certain embodiments, the design match data is determined when the installed location is registered with the electronic tag 58 and a digital twin of the installed cable 10 is generated.

In particular embodiments, the scanner may write information relevant to the cable 10 on each electronic tag 58. The scanner may write information to the electronic tag 58 when the scanner registers the unique serial number of each electronic tag 58 on the cable database. The information written to the electronic tags 58 may be the same information associated with the unique serial number on the cable database. The scanner may write the same information on each electronic tag 58 or may write different information on each electronic tag 58. For example, the pieces of information written to the electronic tag 58 may be inventory data, such as a SKU number, or manufacture date. The relevant information may be written to electronic tag 58 and recorded to the cable database contemporaneously.

In some embodiments, the electronic tags 58 of the cable 10 are scanned at each step of manufacturing to optimize fabrication. Scanning the electronic tags 58 at each step may allow for predicting manufacturing defects as the cable 10 is fabricated. For example, relevant manufacturing data may be written to each electronic tag 58 at each step, uploaded to the cable database, or both written to the electronic tags 58 and uploaded to the cable database. Uploading the relevant manufacturing data to the cable database may allow for real-time monitoring of manufacturing processes. Real-time monitoring of manufacturing process may allow for nearly immediate identification of defects in the cable 10 and allow for fast correction, saving costs in materials and labor. The manufacturing data may include, but is not limited to, tension on the tag tape 59, tension on the internal lines 20, extrusion pressures during the sheathing process, extrusion temperatures during the sheathing process, batch numbers, production machine identification, or the machine operator running a respective production machine.

The manufacturing data may be temporarily written to the electronic tags 58 and removed prior to shipment and deployment of the cable 10. In certain embodiments, the manufacturing data may remain on electronic tags 58 for the lifetime of the cable 10. The manufacturing data may be uploaded to the cable database and may be analyzed for anomalies to predict potential defects. In some embodiments, artificial intelligence (AI) models may analyze the manufacturing data to form predictive models to predict potential defects points. For example, the AI models may analyze the manufacturing data uploaded to the cable database to predict potential defects in the cable 10 prior to shipment or deployment of the cable 10. For example, the AI model may correlate batch data, production machine data, and operator data to predict potential defects in the cable 10. Predicting potential defects in the cable 10 prior to shipment or deployment may reduce or prevent delays in projects as a result of defective materials, which may provide substantial cost and time savings. The manufacturing data may be analyzed by the AI model in real-time. In such embodiments, out-of-spec cables 10 at a particular process of manufacturing may be flagged for containment by the AI model. Containing out-of-spec cables 10 early in the manufacturing process may reduce cost in the form of scrap material. Additionally or alternatively, the AI model may analyze the manufacturing data in real-time for proactive adjustments of manufacturing processes.

In some embodiments, the electronic tags 58 may be scanned for manufacturing data, after deployment throughout the lifetime of the cable 10, to form predictive models of potential defects that may develop across the lifetime of the cable 10. For example, the manufacturing data collected across the lifetime of the cable 10 may be analyzed by AI models to predict delayed development of defects in the cable 10.

Although the method steps are described in a specific order, it should be understood that other steps may be performed in between described steps, described steps may be adjusted so that they occur at slightly different times, or the described steps may occur in any order unless otherwise specified.

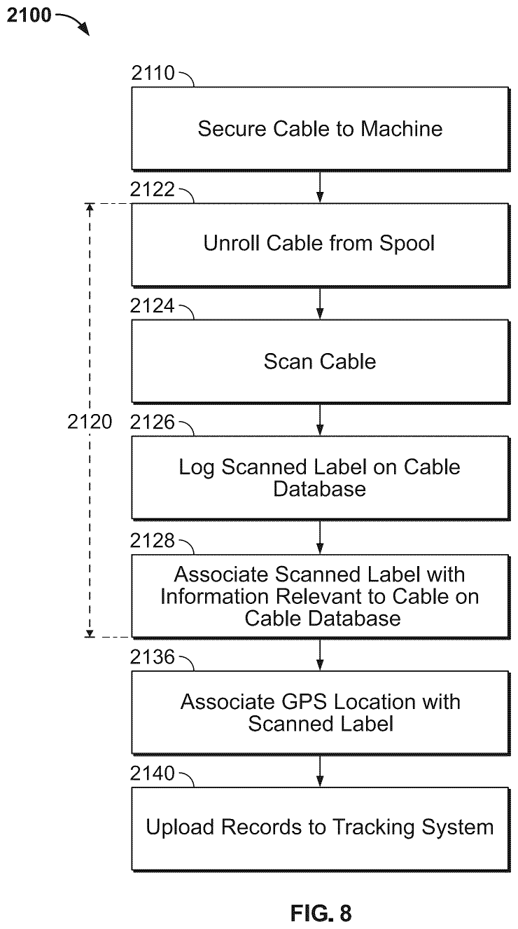

Referring now to FIG. 8, a method 2100 of installing cable is disclosed in accordance with the present disclosure. The method 2100 is described herein with reference to the cable 10 detailed in FIGS. 1-4. The method 2100 includes securing a spool, roll, or quantity of cable to a machine or tool for installing the cable 10 (Step 2110). With the cable 10 secured to the machine or tool, the machine or tool is used to install the cable 10 (Process 2120). For example, the machine may be a lashing machine to lash the cable 10 to another wire or cable or a trenching machine to lay cable underground. In some embodiments, the tool may be a handheld tool or hand operated tool to distribute or install a cable. During installation of the cable 10, the cable 10 is unrolled from a spool or a carrier (Step 2122). As the cable 10 is unrolled, a scanner mounted to the tool or machine scans the cable 10 to identify the cable 10 (Step 2124). The scanner may scan the cable 10 by reading the label 52 on the cable 10. The scanner may read the label 52 optically and/or electronically. For example, the scanner may read an electronic tag 58 of the label 52 as the cable 10 is unrolled past the scanner. In some embodiments, the scanner may visually read a piece of information from the label 52, e.g., a length mark. In some embodiments, the cable 10 is scanned by a scanner that is separate from the machine or tool installing the cable 10, e.g., a handheld scanner that logs the position and the GPS location of the cable 10.

As the scanner scans the cable 10, the scanner may log or record the information of the particular label 52 of the cable 10 (Step 2126). For example, as the scanner scans the cable 10, the scanner may read the unique serial number of the electronic tags 58 and communicate to a cable database which electronic tags 58 were installed. Once the unique serial numbers of the electronic tag 58 are logged on the cable database, the information relevant to the cable 10 may be associated with the electronic tags 58 on the cable database (Step 2128).

Registering the unique serial numbers of the electronic tags 58 to the cable database may aid in managing cable inventory. For example, because the electronic tabs 58 are at known locations along the length of the cable 10, the length of the cable 10 installed and the length of the cable 10 remaining on a spool may be tracked on the cable database. The length of the cable 10 remaining on a spool may be used in a variety of manners. For example, the length of the cable 10 remaining on the spool may be tracked at a vehicle level such that when dispatching a vehicle for installation or repair, the lengths of cables on the vehicle can be known and the lengths may be optimized during installation. In some embodiments, an installation vehicle may be chosen based on the inventory on the vehicle. In certain embodiments, spools may be unloaded from a vehicle after some cable has been used, in such embodiments, the spools may be tracked in a warehouse and chosen to be deployed or loaded onto an installation vehicle based on an amount or cable remaining, age of the cable, or other properties of the cable tracked in the database. The scanner may be in continuous signal communication with the cable database to upload the unique serial numbers to the cable database as the unique serial number are read. In embodiments, the scanner may be in intermittent signal communication with the cable database and may communicate the unique serial numbers to cable database once all of the unique serial numbers are read or after a predetermined number of serial numbers are read. In some embodiments, the scanner may store the unique serial numbers to a storage device, e.g., a Secure Digital card (“SD card”), to be uploaded to the cable database later.

In certain embodiments, the scanner may log and communicate information relevant to the cable 10 in addition to the unique serial numbers of the electronic tags 58. For example, the scanner may log and communicate the installation date, the installation technician, or the spool that the cable 10 originated and associate that information with the unique serial numbers of the electronic tags 58. In such an embodiment, the scanner may only read the unique serial numbers of the electronic tags 58 and associate the installation information with the respective electronic tags 58 on the cable database. In some embodiments, the scanner may additionally write the installation information to the electronic tags 58 themselves.

The scanner may acquire a global positioning system (GPS) location of the particular label 52 and log or record the location of the particular label 52 to the cable database (Step 2136). The scanner may acquire and record the GPS location of the cable 10 through Real-Time Kinematics (“RTK”) to locate the cable 10 to high degree of accuracy. The scanner may acquire and record the depth of the cable 10 by acquiring the depth of each electronic tag 58 when the cable 10 is installed as an underground cable. Acquiring and recording the depth of the electronic tags 58 may aid avoiding damage to existing infrastructure, e.g., utilities such as water or gas, during installation of cable 10. Additionally or alternatively, acquiring and recording the depth of the electronic tags 58 may aid avoiding damage to the cable 10 or other infrastructure during maintenance of the cable 10. The scanner may acquire the depth of the electronic tags 58 during deployment where the cable 10 is installed in an open trench or by direct drilling, e.g., horizontal directional drilling. In some embodiments, the scanner may acquire and record the depth of the cable 10 after deployment of the cable 10 underground. In such an embodiment, the soil in which the cable 10 is deployed may be taken into consideration by the scanner. For example, the scanner may increase signal strength to acquire the depth of the electronic tags 58 where the soil has a high clay content and may decrease signal strength to acquire the depth of the electronic tags 58 where the soil has a high silt content. In some embodiments, the moisture content of the soil may be considered, with wet soil suggesting using of a higher signal strength. The scanner and the electronic tags 58 may be in signal communication up to a cable deployment depth of 5 feet (1.6 meters). After a cable or a plurality of cables are installed, the scanner may upload a log or records of the location and/or GPS location of a particular label 52 or a cable 10 such that a map of the installed cable 10 is created in a tracking system (Step 2140). In embodiments, the scanner may continuously upload a log or record of the location and/or GPS location of a particular label 52 or a cable 10 during installation. The tracking system may be separate and distinct from the cable database. For example, the tracking system may be a system for developing maps of installed cables 10. In embodiments, the GPS coordinates and the depth of the cable 10 may be registered as the installed location and correlated with design match data to create a digital twin of the engineering design to confirm the installed position of the cable 10, as described below. Deviations between the digital twin and the engineering design may be indicated on the digital twin. Deviations may be corrected by repositioning the cable 10 and re-correlating the GPS coordinates and the depth of the cable 10 with design match data to update the digital twin. In some embodiments, the cable 10 may not be repositioned to correct deviations. For example, where a deviation is minor and is not application critical, the deviation may be notated on the cable database for recordation.

In some embodiments, the electronic tags 58 are scanned during installation of the cable 10 to create a digital twin of the deployed cable 10 within the context of the cable network. The digital twin is a virtual replica of the physical cable network. The digital twin may be used to validate installation of the cable 10. For example, the digital twin may be compared to an engineering design of the cable network to confirm proper installation. In some embodiments, AI models may validate the digital twin against the engineering design. In such embodiments, the AI model may flag deviations between the virtual model and the engineering design. The AI model may flag deviations in real-time. For example, the electronic tags 58 may be scanned contemporaneously as the cable 10 is deployed, e.g., laid in a trench. If a deviation between the digital twin and the engineering design is detected, the AI model may flag the deviation. In such embodiments, a deviation may be quickly recognized, located, and corrected if necessary. If a deviation is minor, not requiring correction, the deviation may be notated within the digital twin to maintain accurate records of the cable network. Flagging deviations in real-time may reduce network deployment times which may significantly reduce costs. Specifically, real-time flagging of deviations by the AI model may prevent or reduce a need to manually validate cable deployment to identify deviations.

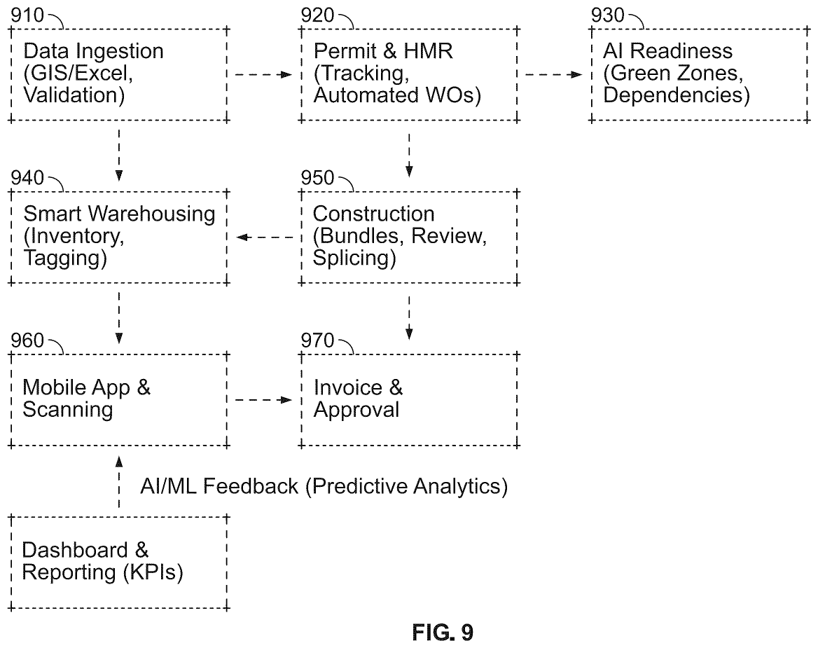

Referring to FIG. 9, a flowchart illustrating an example project management workflow for deploying the fiber 10. The cable database may execute the project management workflow. The cable database may be a cloud-based database. In executing the project management workflow, data, e.g., manufacturing data, design match data, or other pieces of information on the electronic tags 58, is ingested into the cable database (Operation 910). In embodiments, the cable database may ingest the data in the form of GIS files, e.g., Shapefiles, GeoJSON files, GeoPackage files, KML files, KMZ files, LiDAR files, or GeoTIFF files. The data may be validated concurrently when ingested to the cable database. The cable database may communicate with permitting systems or work order systems (Operation 920). The AI model may be readied with the ingested data (Operation 930). The AI model may be readied concurrently with ingestion of the data to the cable database. The AI model may analyze data on the cable database in real-time throughout the entire workflow. A respective cable 10 may be tracked through inventory by smart warehousing operations of the cable database (Operation 940). For example, information may be associated with the electronic tags 58 of the cable 10 on the cable data relevant to inventory such as warehouse location, inventory information, a serial number of the cable 10, a stock keeping unit (SKU) of the cable 10, a name of the product, a production batch of the cable 10, a manufacturing date of the cable 10. Additionally or alternatively, a cable 10 may be tracked through a construction project (Operation 950). For example, a respective cable 10 may be tracked during deployment and associated with work orders and field reviews on the cable database. For example, the cable 10 may be scanned during a field review to collect data to generate the digital twin of the deployed cable 10. The cable 10 may be scanned by the scanner and the relevant information collected and uploaded to the cable database for the analysis by the AI models (Operation 960). The cable database may generate an invoice (Operation 970). The cable database may communicate with project management systems to display visual representations of the data collected throughout the project management workflow. For example, a side-by-side comparison of the engineering design and the digital twin may be displayed. In some embodiments, the AI model may provide for natural language queries of the status of a construction project. For example, a technician may query a project management system in communication with the cable database to predict delay in the construction project. In such embodiment, the AI model may analyze data on the cable database to predict potential delays.

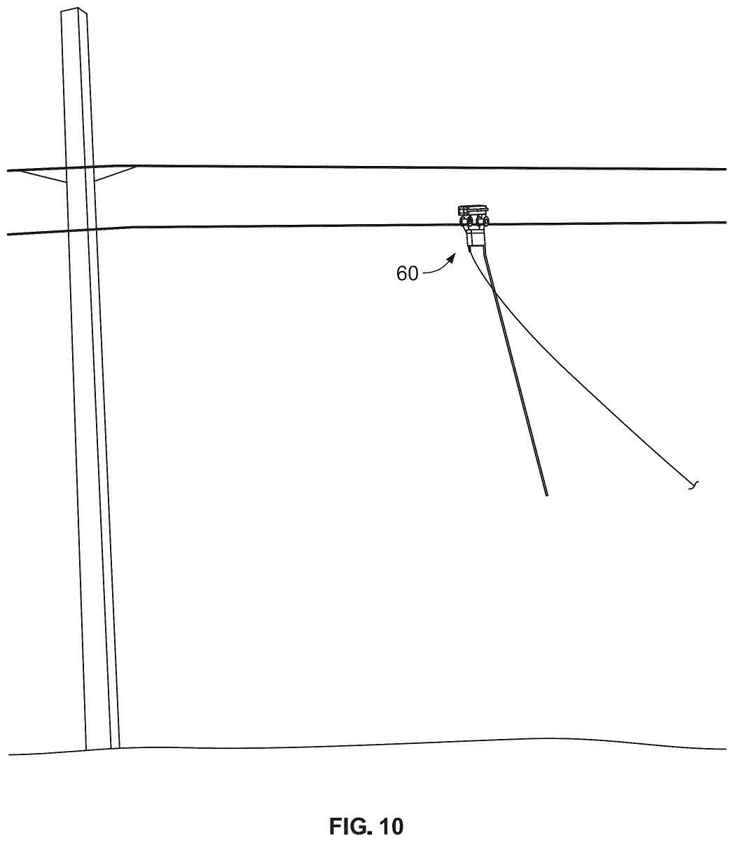

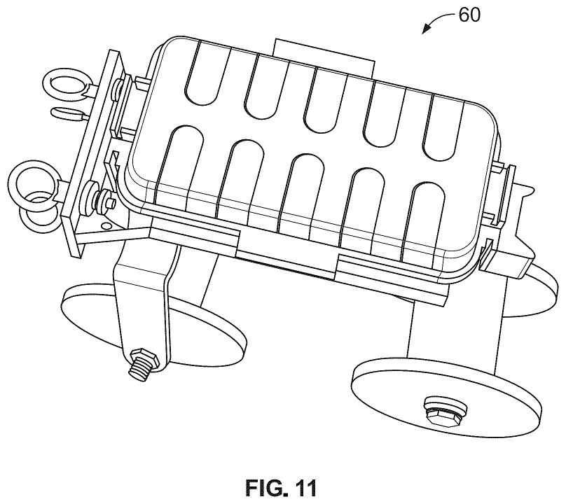

Referring to FIGS. 10 and 11, in certain embodiments, a remote drone 60 may carry the scanner and scan the cable 10. The remote drone 60 may be an aerial drone that fly along one or more nearby cables 10 scanning the electronic tags 58 therein. The remote drone 60 may scan the cable 10 when the cable is buried underground or suspended along overhead communication or energy transmission poles. In embodiments, the remote drone 60 may be a land-based drone that drives along the ground surface scanning the electronic tags 58 within one or more nearby cables 10. In some embodiments, the remote drone 60 may be a line drone that move along communication lines or power transmission lines to scan the electronic tags 58 within one or more nearby cables 10. In embodiments, the scanner may be mounted on a cable lasher to scan the electronic tags 58 when the cable 10 is lashed. In certain embodiments, the scanner may be mounted to a bucket of a bucket truck used in deployment of overhead cables. In particular embodiments, the scanner may be worn on the body by a technician that is deploying the cable 10 when deploying the cable 10.

Although the method operations or steps are described in a specific order, it should be understood that other operations and steps may be performed in between described operations and steps, described operations and steps may be adjusted so that they occur at slightly different times, or the described operations and steps may occur in any order unless otherwise specified.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

1. A cable having a first end and a second end with a length of the cable being defined between the first end and the second end, the cable comprising:
an outer jacket;
a plurality of internal lines disposed within the outer jacket; and
a plurality of labels secured at predetermined intervals along the length of the cable, each label of the plurality of labels including an electronic tag configured to communicate with a scanner external to the cable when the cable is buried underground, each electronic tag having information relevant to the cable stored thereon, the information relevant to the cable including at least a unique serial number associated with each respective electronic tag.

2. (canceled)

3. The cable according to claim 1, wherein the electronic tag is configured to have information relevant to the cable written thereon before or after installation of the cable.

4-6. (canceled)

7. The cable according to claim 1, further comprising a tag tape extending along the length of the cable, the electronic tags secured to the tag tape.

8. The cable according to claim 7, wherein the tag tape is attached to an interior surface of the outer jacket of the cable.

9. The cable according to claim 7, wherein the tag tape is embedded within the outer jacket of the cable.

10. The cable according to claim 1, further comprising a core extending the length of the cable that is made of a toneable material.

11. The cable according to claim 1, further comprising a core extending the length of the cable that is made of a non-toneable material.

12. The cable according to claim 1, wherein the cable does not include a continuous toneable element.

13-14. (canceled)

15. A cable having a first end and a second end with a length of the cable being defined between the first end and the second end, the cable comprising:
an outer jacket having an outer surface;
a plurality of internal lines disposed within the outer jacket; and
a plurality of labels secured at predetermined intervals along the length of the cable, each label of the plurality of labels including:
an electronic tag having information relevant to the cable stored thereon, each electronic tag configured to communicate with a scanner external to the cable when the cable is buried underground up to a depth of 5 feet, the information relevant to the cable including at least a unique serial number associated with each respective electronic tag; and
a visual indicia printed on or applied to the outer surface of the outer jacket, each visual indicia including information relevant to the cable.

16. (canceled)

17. The cable according to claim 15, wherein the electronic tag is configured to have information relevant to the cable written thereon before or after installation of the cable.

18. (canceled)

19. The cable according to claim 15, further comprising a core comprising a core extending the length of the cable that is made of a toneable material.

20. The cable according to claim 15, further comprising a core extending the length of the cable that is made of a non-toneable material.

21. The cable according to claim 15, further comprising a tag tape extending along a length of the cable, the electronic tags secured to the tag tape.

22. The cable according to claim 21, wherein the tag tape extends along the entire length of the cable.

23. A method of manufacturing a cable, the method comprising:
sheathing a plurality of lines to form a cable; and
labeling the cable at predetermined intervals along a length of the cable, labeling the cable comprising:
disposing an electronic tag within an outer jacket of the cable; and
registering information relevant to the cable on a cable database, the relevant information including at least a unique serial number associated with each respective electronic tag.

24. The method according to claim 23, comprising associating information relevant to the cable with each electronic tag.

25. The method according to claim 24, wherein associating information relevant to the cable with each electronic tag includes associating a respective length mark of the cable with the respective electronic tag.

26. The method according to claim 25, wherein registering information relevant to the cable on the cable database includes registering the length mark of each electronic tag on the cable database.

27. The method according to claim 26, wherein registering the length mark of each electronic tag on the cable database calculates and records a total cable length on the cable database.

28. (canceled)

29. The method according to claim 23, wherein registering information relevant to the cable on the cable database includes associating design match data with each electronic tag.

30-44. (canceled)
